(19) United States
(12) Patent Application Publication
(10) Pub. No.: US 2008/0276462 A1
(43) Pub. Date: Nov. 13, 2008

(54) Foldable knife

(76) Inventor: Chih-Chen Kao, Taoyuan City (TW)

Correspondence Address: BACON & THOMAS, PLLC, 625 SLATERS LANE, FOURTH FLOOR, ALEXANDRIA, VA, 22314-1176, US

(21) Appl. No.: 11/798,076

(22) Filed: May 10, 2007

(51) Int. Cl. B26B 1/02

(52) U.S. Cl. 30/155

(57) ABSTRACT

A foldable knife includes a knife handle having a first end pivotally connected with a pivot and a blade having a first end pivotally connected to the pivot. An elastic member is pivotably received in the knife handle, and has a first end extended to a portion of the blade adjacent to the pivot, and a second end extended away from the pivot and toward a second end of the knife handle. A slide member is movably received in the knife handle. When the blade is completely received in the knife handle and the slide member is moved to a position engaged with the second end of the elastic member, the first end of the elastic member is tightly engaged with a portion of the blade adjacent to the pivot for elastically releasing the blade into the knife handle.

### FIELD OF THE INVENTION

The present invention relates to a knife, and more particularly to a foldable knife capable of being switched to be elastically or manually released out of the knife handle.

### BACKGROUND OF THE INVENTION

Presently, accompanying with the advances of technologies, consumers' demand for higher quality of life grows continually, and thus various industrial manufacturers are devoted to develop improved products in order to provide more convenience to consumers. The trend of the foregoing advances not only affects high technological products, but also business matters of general affairs. Taking the inconvenient and disadvantageous designs of current products into consideration, the current products are further improved to enhance the convenience thereof and increase the advantages thereof. When the industrial manufacturers design products, the products are designed with the aim of providing higher life qualities and more convenient functions. For example, one foldable knife provides various advantages, such as multi-purpose convenience, and easy to carry. Especially, the foldable knife can be applied to outdoor activities for providing the multi-purpose convenience, which makes it popular among people who are keen on outdoor activities.

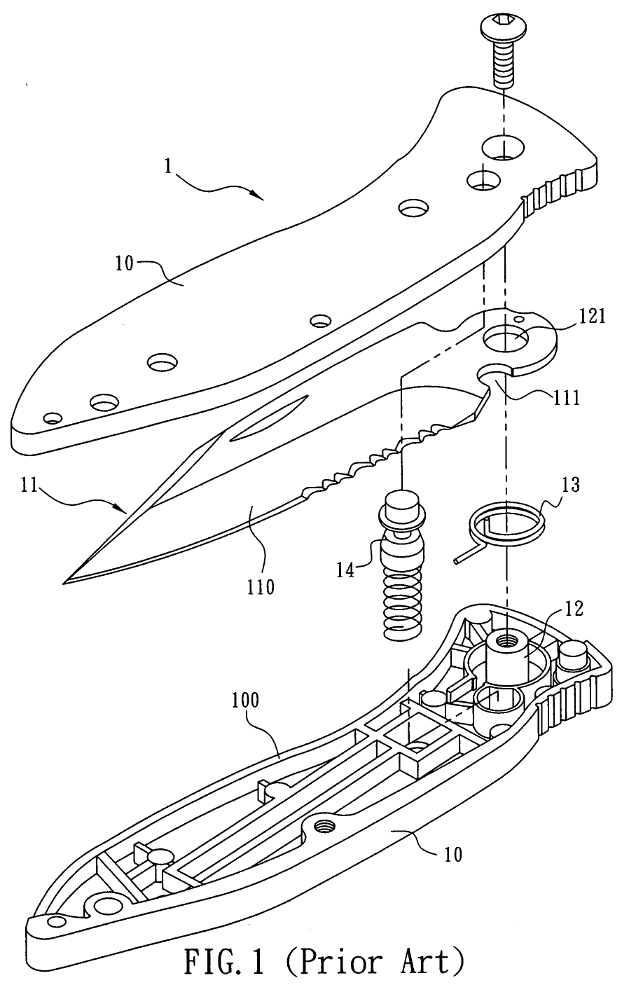

Referring now to FIG. 1, a main structure of a traditional spring-assisted foldable knife 1 is illustrated, wherein the spring-assisted foldable knife 1 comprises a hollow handle 10 and a blade 11. The blade 11 is pivotally connected to the hollow handle 10, and received in the hollow handle 10. The hollow handle 10 has a side edge provided with a slot 100 for elastically releasing the blade 11 out of the hollow handle 10. The blade 11 is provided with a pivotal portion 121 pivotally connected to the hollow handle 10, a knife edge 110, and an engaged indentation 111 formed on an end of the knife edge 110 and adjacent to the pivotal portion 121. The hollow handle 10 is provided with a pivot 12 pivotally connected to the pivotal portion 121 of the blade 11, an elastic member 13 surrounding the pivot 12 for being elastically engaged with the blade 11, and a press switch 14 which is received in the hollow handle 10 and adjacent to the pivot 12, and projected from an outer surface of the hollow handle 10 for optionally engaging with the engaged indentation 111 or releasing the blade 11. When manually pressing the press switch 14, the press switch 14 is disengaged from the engaged indentation 111 of the blade 11, so that the blade 11 can be quickly and elastically released out of the hollow handle 10 by an elastic bias of the elastic member 13. In other words, a user can quickly and easily operate the spring-assisted foldable knife 1 by only one hand.

However, the traditional spring-assisted foldable knife 1 still has several disadvantages in operation as following:

1. Referring back to FIG. 1, the press switch 14 is projected from an exposed portion of the outer surface of the hollow handle 10, so it is easy for the user or a child to accidentally touch the press switch 14 resulting in elastically releasing the blade 11. As a result, there may be a danger to cut or puncture the user or the child due to the originally convenient design of the press switch 14. Furthermore, because the elastic member 13 of the spring-assisted foldable knife 1 provides the elastic bias to quickly and elastically release the blade 11 out of the hollow handle 10, the blade 11 may be accidentally and suddenly released due to the impact caused by any slight external forces, resulting in cutting or puncturing the user if the spring-assisted foldable knife 1 is accommodated in a pocket of the user's clothing. Although the spring-assisted foldable knife 1 provides the multi-purpose convenience in operation, it may be dangerous for the user to use the spring-assisted foldable knife 1 since the knife does not meet more strict safety regulations.

2. Referring back to FIG. 1, the traditional spring-assisted foldable knife 1 may only elastically eject the blade 11. As a result, even though the user wants to temporarily prevent the blade 11 from elastically ejecting from the hollow handle 10 after accidentally pressing the press switch 14 out of concern for the user's safety, the function of elastically ejecting the blade 11 still cannot be temporarily turned off, which causes the inconvenience in operation.

Consequently, it is an important issue for related manufacturers of foldable knives to further develop a novel foldable knife to solve the foregoing disadvantages of the traditional spring-assisted foldable knife 1 and provide more convenience and safer structures.

It is therefore tried by the inventor to develop a foldable knife to solve the problems existing in the foldable knife, as described above.

### SUMMARY OF THE INVENTION

A primary object of the present invention is to provide a foldable knife, which comprises a knife handle and a blade, wherein the knife handle has a first end pivotally connected with a pivot, the blade is pivotally connected to the pivot, and received in the knife handle; the foldable knife further comprises an elastic member and a slide member, wherein the elastic member is pivotably received in the knife handle via another pivot, and has a first end extended to a portion of the blade adjacent to the pivot, and a second end extended away from the pivot and toward a second end of the knife handle, the slide member is movably received in the knife handle and adjacent to the second end of the elastic member, when the blade is received in the knife handle, the slide member can be moved along a direction in the knife handle, so as to control the engaged relationship of the first end of the elastic member and a portion of the blade adjacent to the pivot; when the first end of the elastic member is engaged with the portion of the blade adjacent to the pivot, the elastic member provides a first elastic bias against the portion of the blade for elastically releasing the blade out of the knife handle; and when the first end of the elastic member is not engaged with the portion of the blade adjacent to the pivot, the elastic member stops providing the first elastic bias against the portion of the blade, so that the blade only can be manually released out of the knife handle. As a result, the problem of the traditional foldable knife which cannot be switched to be elastically or manually released out of the knife handle if desired is solved by the present invention.

A secondary object of the present invention is to provide a foldable knife, wherein when the foldable knife is completely received in the knife handle and switched into a status that the blade can be elastically released out of the knife handle, the first end of the elastic member is exactly engaged with the portion of the blade adjacent to the pivot, so that the elastic member provides a second elastic bias against the portion of the blade for elastically releasing the blade into the knife handle, so that the blade will be stably received in the knife handle; only when the blade is gradually rotated about a predetermined angle from an inner space of the knife handle to an outer space thereof, will the elastic member provide the first elastic bias against the portion of the blade for elastically releasing the blade out of the knife handle. As a result, the problem of the traditional foldable knives in which the blade may be suddenly released due to an accidental vibration or the impact caused by an accidental external force is solved by the present invention and the safety of the foldable knife is enhanced.

### BRIEF DESCRIPTION OF THE RELEASINGS

The structure and the technical means adopted by the present invention to achieve the above and other objects can be best understood by referring to the following detailed description of the preferred embodiments and the accompanying releasings, wherein

FIG. 1 is an explosive perspective view of a traditional spring-assisted foldable knife;

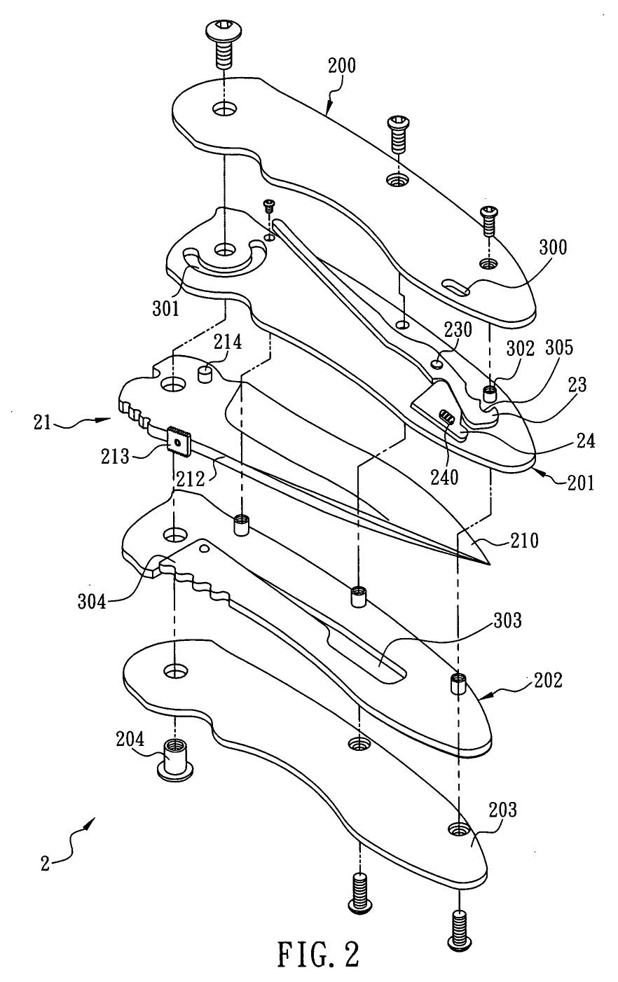

FIG. 2 is an explosive perspective view of a foldable knife according to a first preferred embodiment of the present invention;

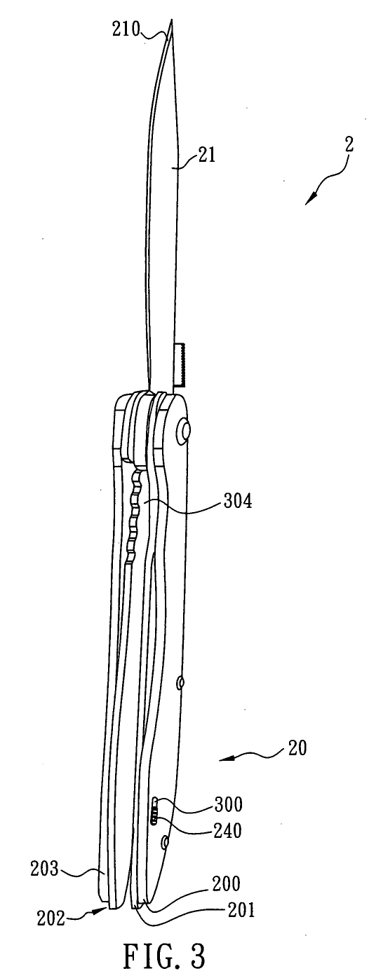

FIG. 3 is an assembled perspective view of a foldable knife according to the first preferred embodiment of the present invention;

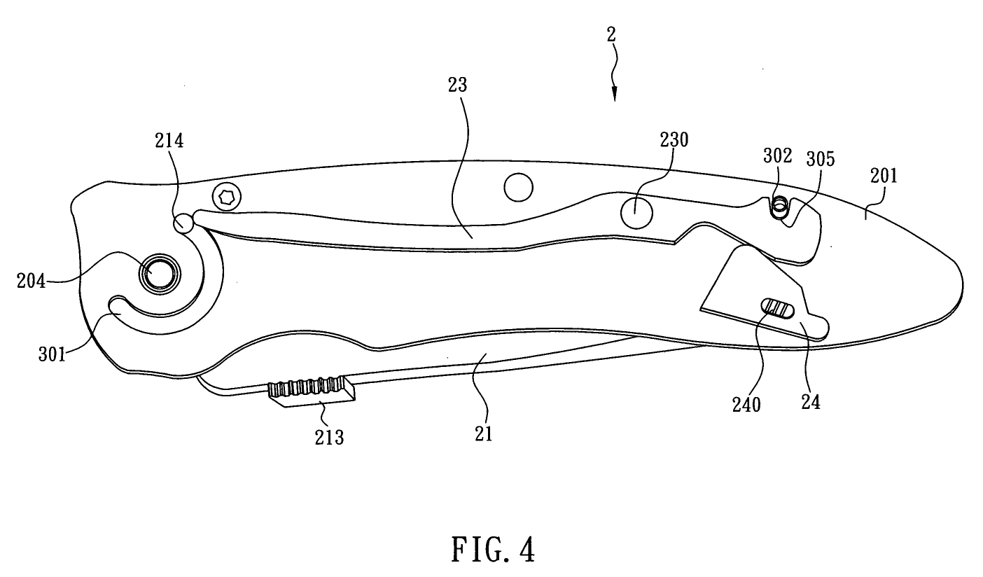

FIG. 4 is a perspective side view of a foldable knife according to the first preferred embodiment of the present invention;

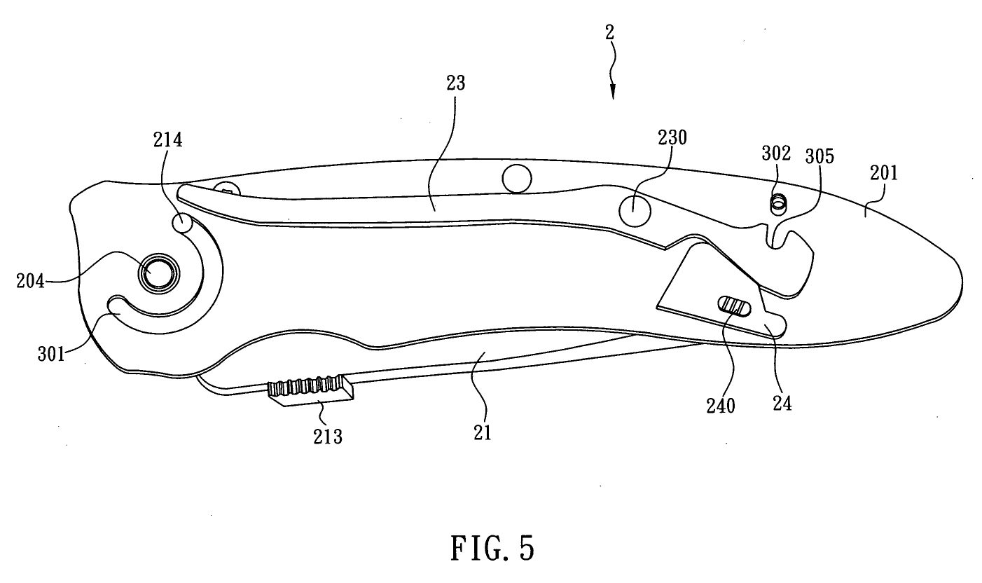

FIG. 5 is another perspective side view of a foldable knife according to the first preferred embodiment of the present invention; and

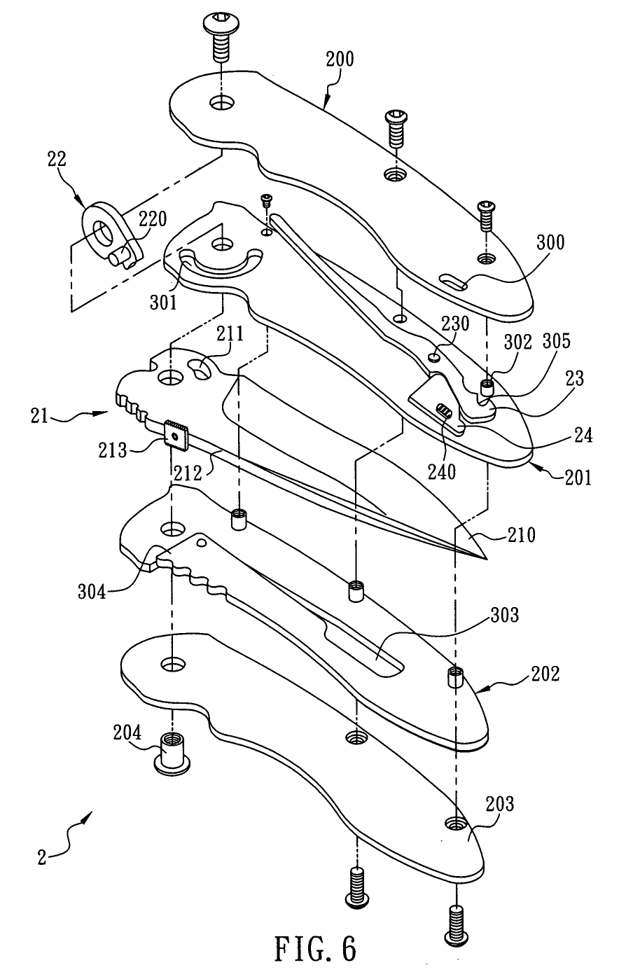

FIG. 6 is an explosive perspective view of a foldable knife according to a second preferred embodiment of the present invention.

### DETAILED DESCRIPTION OF THE PREFERRED EMBODIMENTS

Referring now to FIGS. 2 and 3, a foldable knife according to a first preferred embodiment of the present invention is illustrated. As shown, the foldable knife designated by numeral 2 comprises a knife handle 20 and a blade 21, wherein the knife handle 20 is provided with a first plate 200, a second plate 201, a third plate 202, and a fourth plate 203. The first plate 200, the second plate 201, the third plate 202, and the fourth plate 203 are stacked with each other in turn. Each of the first plate 200, the second plate 201, the third plate 202, and the fourth plate 203 has a first end pivotally connected with a common pivot 204. The blade 21 has a first end away from a knifepoint 210 which is defined as a second end, wherein the first end is pivotally connected to the pivot 204 and sandwiched between the second plate 201 and the third plate 202. The second plate 201 has a side surface defined between the first end and the second end of the second plate 201, wherein the side surface is facing the first plate 200 and pivotally connected with an elastic member 23 via another pivot 230. The elastic member 23 is used to actuate the blade 21 to be elastically released out of the knife handle 20. The foldable knife 2 is further movably provided with a slide member 24 between the first plate 200 and the second plate 201, while the slide member 24 is adjacent to the elastic member 23. The slide member 24 is used to control the engaged relationship between the elastic member 23 and the blade 21, so that the elastic member 23 can be controlled to elastically release the blade 21 out of the knife handle 20. Alternatively, the elastic member 23 can be controlled not to elastically release the blade 21 out of the knife handle 20, so that the blade 21 can only be manually released out of the knife handle 20. As a result, a user can switch the slide member 24 according to demands, so as to select between whether to allow the foldable knife 2 to provide a function of elastically releasing the blade 21 or not by shifting the slide member 24, such that the convenience and the safety of the foldable knife 2 can be substantially enhanced.

Referring back to FIGS. 2 and 3, in the first preferred embodiment of the present invention, the second plate 201 is provided with a retaining slot 301 adjacent to the pivot 204 and partially surrounding the pivot 204, i.e. the retaining slot 301 is extended from a portion of the second plate 201 adjacent to the elastic member 23 along an outwardly rotating direction of the blade 21, so that the retaining slot 301 is substantially a curved slot partially surrounding the pivot 204. The blade 21 is provided with a guiding post 214 adjacent to the pivot 204 and corresponding to the retaining slot 301. The guiding post 214 is extended through the retaining slot 301 to a space between the first plate 200 and the second plate 201. Furthermore, the elastic member 23 has a first end extended to be adjacent to the guiding post 214, and a second end extended away from the pivot 204 and adjacent to the second end of the knife handle 20. The slide member 24 is substantially shaped in a triangular configuration, and provided with a side edge engaged with the second end of the elastic member 23. Referring now to FIG. 4, if the slide member 24 is moved away from the pivot 204 in a status that the blade 21 is received in the knife handle 20, the slide member 24 will be engaged with a portion of the second end of the elastic member 23 which is far away from the pivot 204, so that the first end of the elastic member 23 will be tightly engaged with an outer periphery of the guiding post 214. As a result, the elastic member 23 can provide an elastic bias against the guiding post 214 to elastically release the blade 21 out of the knife handle 20. On the other hand, referring now to FIG. 5, if the slide member 24 is moved toward the pivot 204, the slide member 24 will be engaged with another portion of the second end of the elastic member 23 which is relatively close to the pivot 230 of the elastic member 23 and the second plate 201, so that the first end of the elastic member 23 will not be tightly engaged with the outer periphery of the guiding post 214. As a result, the elastic member 23 cannot provide any elastic bias against the guiding post 214, while the blade 21 can only be manually released out of the knife handle 20. In other words, the foldable knife 2 can provide a function to be switched between a semi-automatic spring-assisted foldable knife and a manually controlled foldable knife, if desired.

Referring now to FIGS. 2, 3, 4 and 5, in the first preferred embodiment of the present invention, when the foldable knife 2 is switched into in a status that the blade 21 completely received in the knife handle 20 can be elastically released out of the knife handle 20, the first end of the elastic member 23 can be exactly engaged with the outer periphery of the blade 21. At this time, the elastic member 23 provides an elastic bias against the blade 21 via the guiding post 214 to actuate the blade 21 to rotate into the knife handle 20, such that the blade 21 can be stably received in the knife handle 20. Moreover, only when the blade 21 is gradually rotated about a predetermined angle from an inner space of the knife handle 20 to an outer space thereof, the elastic member 23 provides the elastic bias against the blade 21 for elastically releasing the blade 21 out of the knife handle 20. As a result, the problem of the traditional foldable knives in which the blade may be suddenly released due to an accidental vibration or the impact caused by an accidental external force is solved by the present invention, and the safety of the foldable knife is enhanced.

Referring now to FIGS. 3 and 6, a foldable knife according to a second preferred embodiment of the present invention is illustrated and similar to the first preferred embodiment. As shown, the foldable knife designated by numeral 2 comprises a knife handle 20, a blade 21, and a guiding member 22, wherein the knife handle 20 is provided with a first plate 200, a second plate 201, a third plate 202, and a fourth plate 203. The first plate 200, the second plate 201, the third plate 202, and the fourth plate 203 are stacked with each other in turn. Each of the first plate 200, the second plate 201, the third plate 202, and the fourth plate 203 has a first end pivotally connected with a common pivot 204. The blade 21 has a first end away from a knife point 210 which is defined as a second end, wherein the first end is pivotally connected to the pivot 204 and sandwiched between the second plate 201 and the third plate 202. The guiding member 22 is pivotally connected to the pivot 204 and sandwiched between the first plate 200 and the second plate 201. Meanwhile, the guiding member 22 can be simultaneously rotated with the blade 21. The second plate 201 has a side surface defined between the first end and the second end of the second plate 201, wherein the side surface is facing the first plate 200 and pivotally connected with an elastic member 23 via another pivot 230. The elastic member 23 is used to actuate the blade 21 via the guiding member 22, so that the blade 21 will be elastically released out of the knife handle 20. The foldable knife 2 is further movably provided with a slide member 24 between the first plate 200 and the second plate 201, while the slide member 24 is adjacent to the elastic member 23. The slide member 24 is used to control the engaged relationship between the elastic member 23 and the guiding member 22, so that the elastic member 23 can be controlled to elastically release the blade 21 out of the knife handle 20 via the guiding member 22. Alternatively, the elastic member 23 also can be controlled not to elastically release the blade 21 out of the knife handle 20 via the guiding member 22, so that the blade 21 only can be manually released out of the knife handle 20. As a result, a user can switch the slide member 24 according to demands, so as to select between whether to allow the foldable knife 2 to provide a function of elastically releasing the blade 21 or not by shifting the slide member 24, such that the convenience and the safety of the foldable knife 2 can be substantially enhanced.

Referring back to FIGS. 3 and 6, in the second preferred embodiment of the present invention, the elastic member 23 has a first end extended to be adjacent to the guiding member 22, and a second end extended away from the pivot 204 and adjacent to the second end of the knife handle 20. The slide member 24 is substantially shaped in a triangular configuration, and provided with a side edge engaged with the second end of the elastic member 23. If the slide member 24 is moved away from the pivot 204 in a status that the blade 21 is received in the knife handle 20, the slide member 24 will be engaged with a portion of the second end of the elastic member 23 which is far away from the pivot 204, so that the first end of the elastic member 23 will be tightly engaged with an outer periphery of the guiding member 22. As a result, the elastic member 23 can provide an elastic bias against the guiding member 22 to indirectly and elastically release the blade 21 out of the knife handle 20. On the other hand, if the slide member 24 is moved toward the pivot 204, the slide member 24 will be engaged with another portion of the second end of the elastic member 23 which is relatively close to the pivot 230 of the elastic member 23 and the second plate 201, so that the first end of the elastic member 23 will not be tightly engaged with the outer periphery of the guiding member 22. As a result, the elastic member 23 cannot provide any elastic bias against the guiding member 22, while the blade 21 only can be manually released out of the knife handle 20. In other words, the foldable knife 2 can provide a function to be switched between a semi-automatic spring-assisted foldable knife and a manually controlled foldable knife, if desired.

Referring still to FIGS. 3 and 6, in the second preferred embodiment of the present invention, the second plate 201 is provided with a retaining slot 301 adjacent to the pivot 204 and partially surrounding the pivot 204, i.e. the retaining slot 301 is extended from a portion of the second plate 201 adjacent to the elastic member 23 along an outwardly rotating direction of the blade 21, so that the retaining slot 301 is substantially a curved slot. The blade 21 is provided with a first guiding portion 211 adjacent to the pivot 204 and corresponding to the retaining slot 301, and the first guiding portion 211 is substantially a slot. The guiding member 22 is provided with a second guiding portion 220 on a side surface which is facing the first guiding portion 211, and the second guiding portion 220 is substantially a post, so that the second guiding portion 220 corresponds to the first guiding portion 211. The second guiding portion 220 is extended toward the first guiding portion 211, and passed through the retaining slot 301 and the first guiding portion 211 in turn. As a result, because the second guiding portion 220 is extended through the first guiding portion 211, the guiding member 22 can be simultaneously rotated with the blade 21 within a curved pathway of the retaining slot 301. Especially, when the elastic member 23 provides an elastic bias against the guiding member 22, the guiding member 22 can be used to actuate the blade 21 within a curved pathway of the retaining slot 301 by the second guiding portion 220 extended through the first guiding portion 211, so that the blade 21 can be elastically released out of the knife handle 20.

In the second preferred embodiment of the present invention, the first guiding portion 211 and the second guiding portion 220 can be suitably varied according to an actual structure of the foldable knife 2, for example, the second guiding portion 220 can be selected from a slot, and the first guiding portion 211 can be selected from a post, wherein the first guiding portion 211 is extended toward the second guiding portion 220, and passed through the retaining slot 301 and the second guiding portion 220 in turn. Alternatively, in addition to the corresponding slot and post structure, the first guiding portion 211 and the second guiding portion 220 can be selected from other corresponding structure according to the actual structure of the foldable knife 2, only if the first guiding portion 211 and the second guiding portion 220 can be used to simultaneously rotate the blade 21 and the guiding member 22.

Referring still to FIGS. 3 and 6, in the second preferred embodiment of the present invention, when the foldable knife 2 is switched into in a status that the blade 21 completely received in the knife handle 20 can be elastically released out of the knife handle 20, the first end of the elastic member 23 can be exactly engaged with the outer periphery of the guiding member 22. At this time, the elastic member 23 provides an elastic bias against the blade 21 via the guiding member 22 to actuate the blade 21 to rotate into the knife handle 20, such that the blade 21 can be stably received in the knife handle 20. Moreover, only when the blade 21 is gradually rotated about a predetermined angle from an inner space of the knife handle 20 to an outer space thereof, the elastic member 23 provides the elastic bias against the blade 21 via the guiding member 22 for elastically releasing the blade 21 out of the knife handle 20. As a result, the problem of the traditional foldable knives in which the blade may be suddenly released due to an accidental vibration or the impact caused by an accidental external force is solved by the present invention, and the safety of the foldable knife is enhanced.

Referring back to FIGS. 2, 4, 5, and 6, in the first and second preferred embodiments of the present invention, the slide member 24 is not only substantially shaped in a triangular configuration, but can also be suitably shaped in various configurations according to the actual structure of the foldable knife 2, only if the elastic member 23 can be used to elastically release the blade 21 out of the knife handle 20. On the other hand, the shifting direction of the slide member 24 between the first plate 200 and the second plate 201 or the engaged relationship between the slide member 24 and the elastic member 23 can also be suitably varied according to the actual structure of the foldable knife 2, only if the foldable knife 2 can control the elastic member 23 to elastically release the blade 21 out of the knife handle 20 by the shift of the slide member 24, as well as the engaged relationship between the slide member 24 and the elastic member 23.

Referring back to FIGS. 2, 3, and 6, in the first and second preferred embodiments of the present invention, the first plate 200 is provided with an opening 300 on a portion thereof which is relatively away from the pivot 204, while the slide member 24 is provided with a flange 240 corresponding to the opening 300. Thus, the flange 240 of the slide member 24 is extended through the opening 300 of the first plate 200, and then protruded from the first plate 200. As a result, when a user needs to adjust the position of the slide member 24 in relation to the first plate 200 for switching into a semi-automatic spring-assisted foldable knife or a manually controlled foldable knife, the flange 240 can be manually operated to control the slide member 24. Moreover, the opening 300 is used to retain a shifting pathway of the flange 240 of the slide member 24, so that the flange 240 of the slide member 24 can only be shifted within an inner space of the opening 300 for preventing the adjustment function of the flange 240 and the slide member 24 from damaging due to possibly excessive shifting the flange 240 and the slide member 24.

Referring back to FIGS. 2, 4, 5, and 6, in the first and second preferred embodiments of the present invention, the second plate 201 is provided with a retaining post 302 on a portion thereof which is adjacent to the second end of the elastic member 23, wherein the retaining post 302 and the slide member 24 are mounted on the opposite side of the second end of the elastic member 23. Meanwhile, the second end of the elastic member 23 is provided with an indentation 305 corresponding to the retaining post 302, so that the indentation 305 can be used to tightly receive the retaining post 302. When the slide member 24 is moved away from the pivot 204, the slide member 24 will be engaged with the second end of the elastic member 23 that is away from the pivot 204. At this time, the retaining post 302 is just tightly received in the indentation 305, so that the stability of the elastic bias against the blade 21 during the elastic member 23 elastically releases the blade 21 out of the knife handle 20 can be substantially increased. Referring back to FIGS. 2, 3, and 6, in the first and second preferred embodiments of the present invention, the blade 21 has a knife back 212 provided with a push portion 213. When the blade 21 is received in the knife handle 20, the push portion 213 is protruded from the knife handle 20. Hence, if a user wants to release the blade 21 out of the knife handle 20, the user can simultaneously hold the foldable knife 2 and push the push portion 213 by only one hand, so that the blade 21 will be manually released out of the knife handle 20. As a result, the convenience of the foldable knife 2 is substantially enhanced.

Referring back to FIGS. 2, 3, and 6, in the first and second preferred embodiments of the present invention, the third plate 202 has a side edge formed with an indentation 303 formed on a portion of the first end of the third plate 202 adjacent to the pivot 204, and extended to a portion of the second end thereof away from the pivot 204, while the portion of the second end of the third plate 202 is provided with a block plate 304 extended along the indentation 303. The block plate 304 has one movable end that is extended to a position adjacent to the blade 21, so that the movable end of the block plate 304 can be movably engaged with the blade 21. When the blade 21 is rotated out of the knife handle 20, the movable end of the block plate 304 is just engaged with the first end of the blade 21, so that the blade 21 is retained outside the knife handle 20 and cannot be optionally rotated for the user to stably cut something by the foldable knife 2. Furthermore, when the blade 21 is rotated again for receiving the blade 21 in the knife handle 20, an outer periphery of the block plate 304 will be forced, so that the block plate 304 will be shifted and disengaged from the blade 21. As a result, the blade 21 will be released and rotated again until the blade 21 is received in the knife handle 20.

Referring back to FIGS. 2, 3, and 6, in the first and second preferred embodiments of the present invention, it should be noted that the knife handle 20 can not only be constructed from the first plate 200, the second plate 201, the third plate 202, and the fourth plate 203, but can also be suitably varied according to the actual structure of the foldable knife 2, only if the knife handle 20 can be pivotally connected to the blade 21. Moreover, the operation mode of the elastic member 23 for elastically releasing the blade 21 out of the knife handle 20 is not limited to providing the guiding post 214 on the blade 21 for being engaged with the elastic member 23 in the first preferred embodiment, or the guiding member 22 of the foldable knife 2 for being engaged with the elastic member 23 to elastically release the blade 21 out of the knife handle 20 in the second preferred embodiment, the operation mode of the elastic member 23 can also be suitably varied according to the actual structure of the foldable knife 2, only if the elastic member 23 can elastically release the blade 21 out of the knife handle 20.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A foldable knife, comprising:
a knife handle having a first end pivotally connected with a first pivot;
a blade having a first end away from a knifepoint which is defined as a second end, the first end thereof being pivotally connected to the pivot and received in the knife handle;
an elastic member pivotably received in the knife handle via a second pivot and having a first end extended to a portion of the blade adjacent to the first pivot, and a second end extended away from the first pivot and toward a second end of the knife handle; and
a slide member movably received in the knife handle and adjacent to the second end of the elastic member;
wherein when the slide member is forced and moved along a first direction in the knife handle, the slide member is engaged with the second end of the elastic member, so that the first end of the elastic member is tightly engaged with a portion of the blade adjacent to the first pivot in a status that the blade is completely received in the knife handle; and when the slide member is forced and moved along a second direction opposite to the first direction, the slide member is disengaged from the second end of the elastic member, so that the first end of the elastic member is not tightly engaged with the portion of the blade adjacent to the first pivot.

2. The foldable knife of claim 1, wherein the slide member is provided with a flange extended through the knife handle and protruded from the knife handle.

3. The foldable knife of claim 2, wherein the knife handle is provided with an opening corresponding to the flange of the slide member.

4. The foldable knife of claim 1, wherein the knife handle is provided with a retaining post on a portion thereof which is adjacent to the second end of the elastic member, and the retaining post and the slide member are mounted on the opposite side of the second end of the elastic member.

5. The foldable knife of claim 4, wherein the second end of the elastic member is provided with an indentation corresponding to the retaining post of the knife handle for tightly receiving the retaining post.

6. The foldable knife of claim 1, wherein the blade has a knife back provided with a push portion protruded from the knife handle.

7. The foldable knife of claim 1, wherein the knife handle has a side edge having an indentation formed on a portion of the first end of the knife handle adjacent to the first pivot and extended to a portion of the second end thereof away from the first pivot, and wherein the portion of the second end of the knife handle is provided with a block plate extended along the indentation, and the block plate has one end extended to a position adjacent to the blade.
